(19) United States
(12) Patent Application Publication
(10) Pub. No.: US 2010/0150562 A1
(43) Pub. Date: Jun. 17, 2010

(54) OPTICAL TRANSMISSION SYSTEM

(75) Inventors: Hyun Jae LEE, Deajeon (KR); Hong Ju Kim, Daejeon (KR); Hyun Woo Cho, Daejeon (KR); Sun Me Kim, Daejeon (KR); Byung Jun Ahn, Daejeon (KR)

Correspondence Address: RABIN & Berdo, PC, 1101 14TH STREET, NW, SUITE 500, WASHINGTON, DC, 20005, US

(73) Assignee: ELECTRONICS AND TELECOMMUNICATIONS RESEARCH INSTITUTE, Daejeon (KR)

(21) Appl. No.: 12/579,045

(22) Filed: Oct. 14, 2009

(30) Foreign Application Priority Data
Dec. 11, 2008 (KR) 10-2008-0125852
Mar. 30, 2009 (KR) 10-2009-0026888

(51) Int. Cl. H04J 14/02

(52) U.S. Cl. 398/81

(57) ABSTRACT

An optical transmission system in which a plurality of optical signals each having a different wavelength are transmitted via a single optical fiber, includes: a first dispersion compensator configured to compensate for wavelength dispersion based on a single wavelength of a plurality of signals transmitted via the optical fiber; a demultiplexer connected to the first dispersion compensator, splitting signals output from the first dispersion compensator into different channels according to their wavelengths, and outputting the same; and a plurality of second dispersion compensators connected to each channel split by the demultiplexer, and compensating for the wavelength dispersion of the mutually different wavelength optical signals.

### CROSS-REFERENCE TO RELATED APPLICATIONS

This application claims the priorities of Korean Patent Application Nos. 10-2008-0125852 filed on Dec. 11, 2008, and 10-2009-0026888 filed on Mar. 30, 2009, in the Korean Intellectual Property Office, the disclosures of which are incorporated herein by reference.

### BACKGROUND OF THE INVENTION

1. Field of the Invention

The present invention relates to an optical transmission system and, more particularly, to an optical transmission system that causes a reception end thereof to pass an optical signal through two dispersion compensators having different dispersion compensation forms and thus provide greater precision in dispersion compensation.

2. Description of the Related Art

Optical communications techniques are rapidly being developed in line with the advancement of optical fiber techniques and the development of optical sources such as semiconductor lasers. In particular, an optical transmission technique in a wavelength division multiplexing (WDM) scheme that transmits optical signal pulses of different wavelength bands via a single optical fiber is taking hold as a core technology in the optical communications sector. In addition, the development of an optical fiber amplifier including erbium has settled the problem of energy loss in optical signal pulses during long-distance transmissions; so, accordingly, optical signal pulses may now be transmitted for long distances.

When optical signal pulses of a wavelength band of 1530 nm to 1565 nm, most commonly used in the optical communication technique, are multiplexed and transmitted via a single optical fiber, the optical fiber has each fine, different refractive index over a wavelength of each optical signal pulse. Thus, due to the different refractive indices in the optical fiber, dispersion whereby the optical signal pulses transmitted via the single optical fiber widen is caused, as transmission length increases. In addition, as the transmission distance increases, the dispersion of the optical signal pulses increases, making mutually adjacent optical signal pulses overlap, resulting in a problem in that a reception end of the optical communication system cannot easily discriminate between the received optical signal pulses.

### SUMMARY OF THE INVENTION

An aspect of the present invention provides an optical transmission system allowing for a precise dispersion compensation operation by using different dispersion compensators according to a signal band received by the reception end of the optical transmission system.

According to an aspect of the present invention, there is provided an optical transmission system in which a plurality of optical signals, each having a different wavelength, are transmitted via a single optical fiber, including: a first dispersion compensator configured to compensate for a wavelength dispersion based on a single wavelength of a plurality of signals transmitted via the optical fiber; a demultiplexer connected to the first dispersion compensator, splitting signals output from the first dispersion compensator into different channels according to their wavelengths, and outputting the same; and a plurality of second dispersion compensators connected to each channel split by the demultiplexer, and compensating for each wavelength dispersion of the mutually different wavelength optical signals.

The first dispersion compensator may be a tunable dispersion compensator module (TDCM).

The second dispersion compensator may be a fixed dispersion compensator module (FDCM).

The optical transmission system may further include: a plurality of optical amplifiers respectively connected to the second dispersion compensators and amplifying each of the channel signals which have been split by the demultiplexer.

The optical transmission system may further include: a pre-amplifier configured to amplify a signal input to the first dispersion compensator, and in this case, the optical transmission system may further include: a plurality of optical amplifiers respectively connected to each of the second dispersion compensators and amplifying each of the channel signals which have been split by the demultiplexer.

According to another aspect of the present invention, there is provided an optical transmission system in which a plurality of optical signals each having a different wavelength are transmitted via a single optical fiber, including: a first demultiplexer configured to split a plurality of optical signals transmitted via the optical fiber into signals of pre-set bands and output the same; a first dispersion compensator connected to each of the band channels which have been split by the first demultiplexer and compensating for wavelength dispersion based on one wavelength among a plurality of signals included in output signals of each band; a plurality of second demultiplexers connected to each of the plurality of first dispersion compensators, splitting signals output from the first dispersion compensators into signals of different channels according to their wavelengths, and outputting the same; and a plurality of second dispersion compensators connected to each of the channels which have been split by the plurality of second demultiplexers and compensating for wavelength dispersion of each of the mutually different wavelength optical signals as outputted.

The first dispersion compensators may be tunable dispersion compensator modules (TDCMs).

The second dispersion compensators may be fixed dispersion compensator modules (FDCMs).

The optical transmission system may further include: a plurality of optical amplifiers connected to a front stage of each of the first dispersion compensators and amplifying each signal of each band output from the first demultiplexer.

The optical transmission system may further include: a pre-amplifier configured to amplify a signal input to the first demultiplexer.

The optical transmission system may further include: a plurality of optical amplifiers connected to each of the second dispersion compensators and amplifying each of channel signals which have been split by the second demultiplexers.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a schematic block diagram of an optical transmission system according to an exemplary embodiment of the present invention;

FIG. 2 is a schematic block diagram of an optical transmission system according to another exemplary embodiment of the present invention;

FIG. 3 is a schematic block diagram of an optical transmission system according to another exemplary embodiment of the present invention; and

FIGS. 4 and 5 are schematic block diagrams of an optical transmission system according to another exemplary embodiment of the present invention.

### DETAILED DESCRIPTION OF THE PREFERRED EMBODIMENT

Exemplary embodiments of the present invention will now be described in detail with reference to the accompanying drawings. The invention may however be embodied in many different forms and should not be construed as limited to the embodiments set forth herein. Rather, these embodiments are provided so that this disclosure will be thorough and complete, and will fully convey the scope of the invention to those skilled in the art. In the drawings, the shapes and dimensions may be exaggerated for clarity, and the same reference numerals will be used throughout to designate the same or like components.

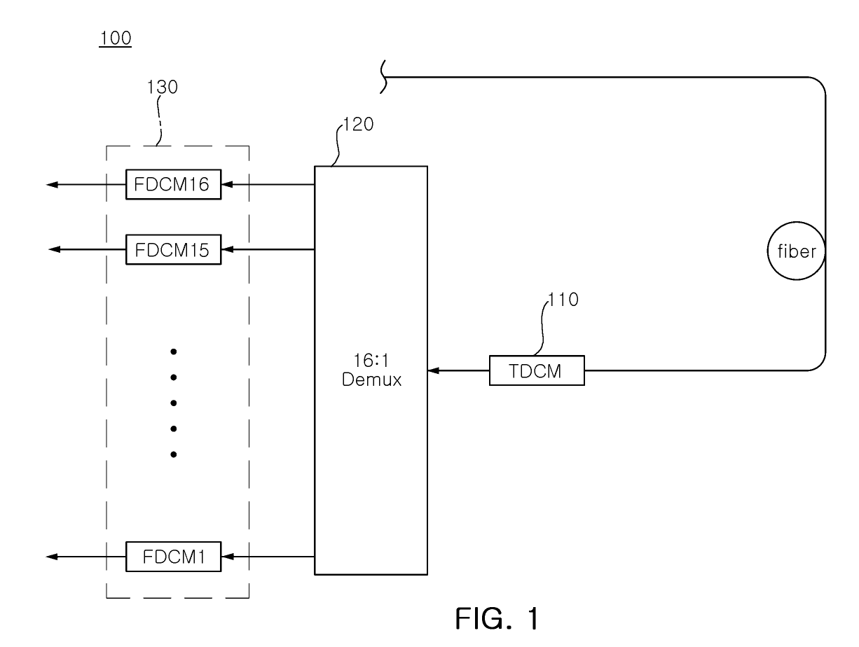

FIG. 1 is a schematic block diagram of an optical transmission system according to one exemplary embodiment of the present invention.

With reference to FIG. 1, an optical transmission system 100 according to one exemplary embodiment of the present invention may include a first single dispersion compensator 110, a demultiplexer 120, and a plurality of second dispersion compensators 130.

In the present exemplary embodiment, the optical transmission system 100 may multiplex a plurality of optical signals each having a different wavelength by means of a multiplexer and transmit the same via a single optical fiber. In the optical transmission system according to the present exemplary embodiment, a power amplifier may be used before the transmission signals are input to the optical fiber. In addition, a plurality of optical amplifiers may be used on the optical fiber for a long-distance transmission.

The first dispersion compensator 110 may be a tunable dispersion compensator module (TDCM) that can perform a precise dispersion compensation operation. The TDCM is an optical element based on a fiber grating, which compensates a certain dispersion value when an input signal is reflected. The TDCM changes an initial dispersion value of the fiber grating according to an external force such as heat, bending, straining, and the like. For example, if the fiber grating is bent into an S shape, the fiber grating is strained, changing the period of the grating and causing a chirp phenomenon. Accordingly, the dispersion value is changed, and in particular, the dispersion value is changed according to the degree of bending.

The TDCM may use a chirped fiber grating. In general, a optical signal pulse with a center wavelength λ₁ includes several wavelengths within a certain range (λ₁±δ nm) based on λ₁, as well as the center wavelength λ₁. Accordingly, the longest wavelength (λ₁+δ nm) constituting the optical signal pulse with the center wavelength λ₁ is relatively slow in its transmission speed compared with other wavelengths, in which, thus, dispersion occurs severely as the transmission distance becomes longer. Meanwhile, the shortest wavelength (λ₁−δ nm) is relatively faster in its transmission speed compared with other wavelengths, in which the least amount of dispersion may occur although the transmission distance becomes longer. Thus, in order to compensate for the dispersion of the longest wavelength (λ₁+δ nm) constituting the optical signal pulse of the center wavelength λ₁, a reflection path within the chirp fiber grating needs to be shortened, while in order to compensate for the dispersion of the shortest wavelength (λ₁−δ nm) constituting the optical signal pulse, the reflection path in the chirp fiber grating needs to be relatively long to compensate for the dispersion of the optical signal pulse over the long distance transmission.

In the present exemplary embodiment, the TDCM 110 may perform a precise dispersion compensation operation on all of a plurality of wavelength signals transmitted via the optical fiber based on one of the plurality of wavelength signals.

The demultiplexer 120 may split the signals output from the first dispersion compensator 110 into signals of different channels according to their wavelengths and output the same. In the present exemplary embodiment, a 16:1 demultiplexer may be used to split the transmitted optical signals by wavelength and output the same.

The second dispersion compensators 130 are connected to the respective channels which have been split by the demultiplexer 120 and compensate for the wavelength dispersion of each of the output optical signals of mutually different wavelengths. In the present exemplary embodiment, the second dispersion compensators 130 maybe fixed dispersion compensator modules (FDCMs).

The FDCMs 130 may compensate for fixed dispersion. The fixed dispersion may be a chromatic dispersion set per unit length of a waveguide having a fixed refractivity. The fixed dispersion may be relatively fixed over the environmental conditions of the optical fiber. For example, 17 ps/nn·km with respect to a standard single mode fiber may represent a substantially 17 picosecond (ps) chromatic dispersion in a 10-kilometer system transmitting data with a bandwidth of 0.1 nanometer (nm). The FDCM may be economical compared with the TDCM.

In the present exemplary embodiment, the FDCMs 130 may compensate signals which have been dispersion-compensated based on one wavelength signal by the TDCM 110. In the present exemplary embodiment, the FDCMs 130 may correspond to the number of split channels. In this case, the FDCM 130 may be omitted for a channel with respect to the optical signal whose wavelength is used as the reference in the TDCM 110.

In this manner, in the present exemplary embodiment, the precise dispersion compensation operation is performed on the transmitted optical signals by using the single TDCM 110, and the precisely compensation-compensated signals are split by channels by using the demultiplexer 120, and the split signals are allowed to pass through the FDCMs 130, thus performing a precise dispersion compensation operation. In addition, because the required number of relatively high-priced TDCMs is reduced, a more economical optical transmission system can be implemented.

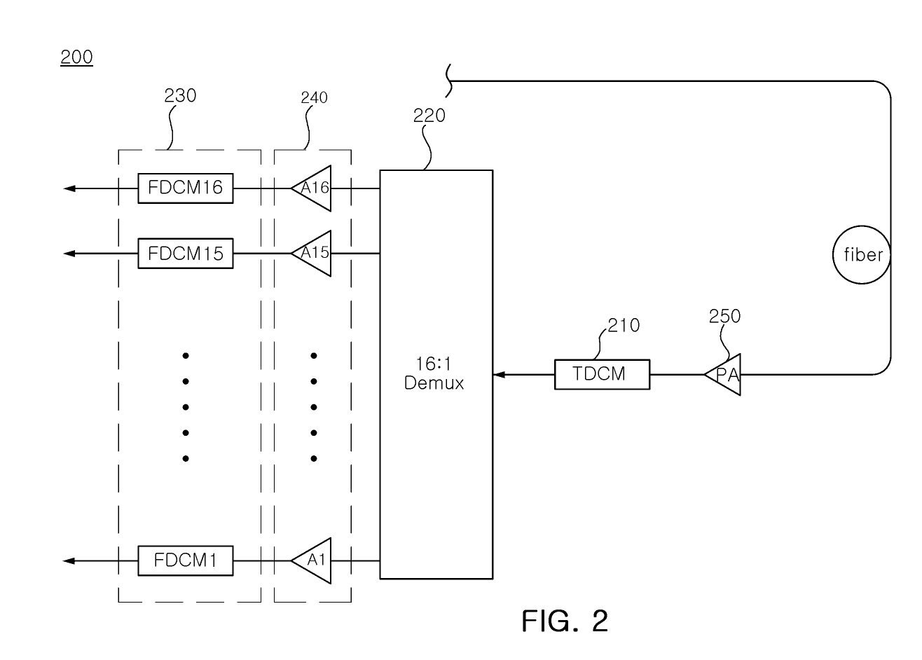

FIG. 2 is a schematic block diagram of an optical transmission system according to another exemplary embodiment of the present invention.

With reference to FIG. 2, an optical transmission system 200 according to the present exemplary embodiment may include a single first dispersion compensator 210, a demultiplexer 220, a plurality of second dispersion compensators 230, a plurality of optical amplifiers 240, and a pre-amplifier 250.

The optical transmission system 200 according to the present exemplary embodiment may multiplex a plurality of optical signals each having a different wavelength by means of a multiplexer and transmit the same via a single optical fiber. In the optical transmission system 200 according to the present exemplary embodiment, a power amplifier may be employed before the transmission signals are input to the optical fiber. In addition, a plurality of optical amplifiers may be employed on the optical fiber for a long-distance transmission.

The first dispersion compensator 110 may be a tunable dispersion compensator module (TDCM) that can perform a precise dispersion compensation operation. In the present exemplary embodiment, the TDCM 210 may perform a precise dispersion compensation operation on all of a plurality of wavelength signals transmitted via the optical fiber based on one of the plurality of wavelength signals.

The demultiplexer 220 may split the signals output from the first dispersion compensator 210 into signals of different channels according to their wavelengths and output the same. In the present exemplary embodiment, a 16:1 demultiplexer may be used to split the transmitted optical signals by wavelength and output the same.

The second dispersion compensators 230 are connected to the respective channels which have been split by the demultiplexer 220 and compensate wavelength dispersion of each of the output optical signals of mutually different wavelengths. In the present exemplary embodiment, the second dispersion compensators 230 may be fixed dispersion compensator modules (FDCMs).

The optical amplifiers 240 may amplify each signal of each channel which has been split by the demultiplexer 220 and transmit the same to the second dispersion compensators 230. If the power of the optical signal of each channel which has been split by the demultiplexer 230 is low, the optical amplifiers 240 may amplify the signals.

The optical transmission system according to the present exemplary embodiment may further include a pre-amplifier (PA) 250 connected to a front end of the first dispersion compensator 210.

The PA 250 may amplify a signal transmitted through the optical fiber, compensate dispersion of the signal by using a dispersion compensation module (DCM), amplify the dispersion-compensated signal, and transmit the amplified signal to the first dispersion compensator 210.

In the present exemplary embodiment, the FDCMs 230 may compensate the signals of respective channels which have been dispersion-compensated based on one wavelength signal by the TDMA 210. In the present exemplary embodiment, the FDCMs 230 may correspond to the number of split channels. In this case, the FDCM 230 may be omitted for a channel with respect to the optical signal whose wavelength is used as the reference in the TDCM 210.

In this manner, in the present exemplary embodiment, the precise dispersion compensation operation is performed on the transmitted optical signals by using the single TDCM 210, and the precisely compensation-compensated signals are split by channels by using the demultiplexer 220, and the split signals are allowed to pass through the FDCMs 230, thus performing a precise dispersion compensation operation. In addition, because the required number of relatively high-priced TDCMs may be reduced, a more economical optical transmission system can be implemented.

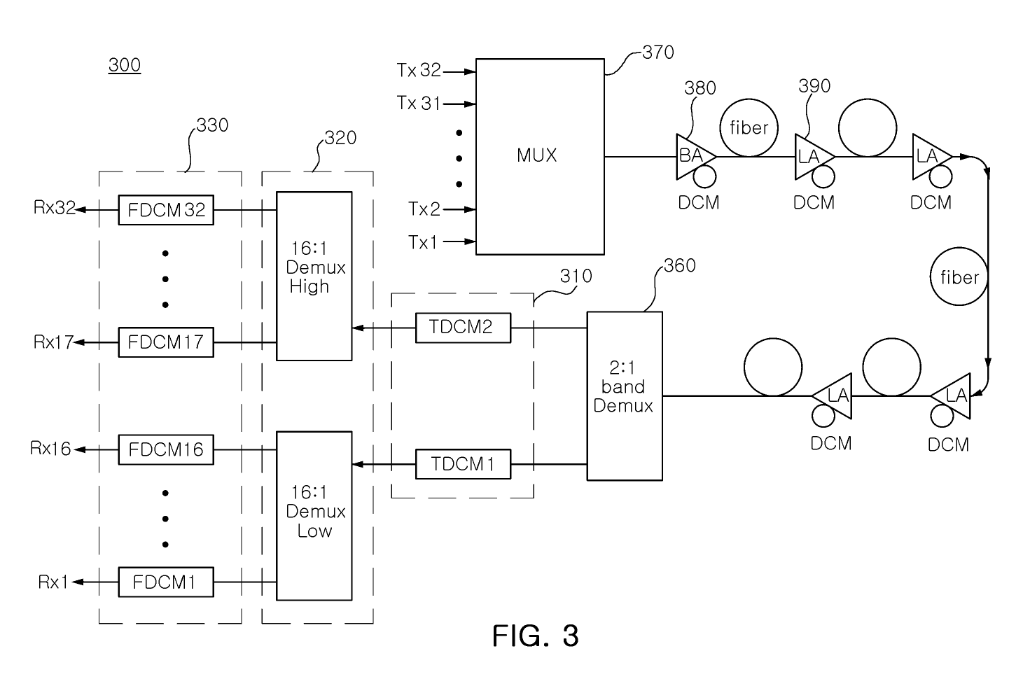

FIG. 3 is a schematic block diagram of an optical transmission system according to another exemplary embodiment of the present invention.

With reference to FIG. 3, an optical transmission system 300 according to the present exemplary embodiment may include a first demultiplexer 360, first dispersion compensators 310, second demultiplexers 320, and second dispersion compensators 330.

The optical transmission system 300 according to the present exemplary embodiment may multiplex a plurality of optical signals each having a different wavelength by means of a multiplexer and transmit the same via a single optical fiber. In the optical transmission system 300 according to the present exemplary embodiment, a power amplifier may be employed before the transmission signals are input to the optical fiber. In addition, a plurality of optical amplifiers 390 maybe employed on the optical fiber for a long-distance transmission.

The first demultiplexer 360 may split a plurality of optical signals transmitted through the optical fiber into signals of pre-set bands and output the same. In the present exemplary embodiment, as the demultiplexer 360, a 2:1 demultiplexer may be used to split the transmitted optical signals into an optical signal of a high band wavelength and an optical signal of a low band wavelength and output the same.

The first dispersion compensators 310 are connected to each of the band channels which have been split by the first demultiplexer 360 and compensate for wavelength dispersion based on one wavelength among the plurality of signals included in the outputs signals by bands. In the present exemplary embodiment, the first dispersion compensators 310 may include two first dispersion compensators (TDCM1 and TDCM2) to perform wavelength dispersion compensation on the high band signal and low band signal.

The first dispersion compensators 310 may be tunable dispersion compensator modules (TDCMs) that can perform a precise dispersion compensation operation. The TDCM is an optical element based on a fiber grating, which compensates a certain dispersion value when an input signal is reflected. The TDCM changes an initial dispersion value of the fiber grating according to an external force such as heat, bending, straining, and the like. For example, if the fiber grating is bent into an S shape, the fiber grating is strained to change the period of the grating, causing a chirp phenomenon. Accordingly, the dispersion value is changed, and in particular, the dispersion value is changed according to the degree of bending.

The TDCM may use a chirped fiber grating. In general, a optical signal pulse with a center wavelength λ₁ includes several wavelengths within a certain range (λ₁±δ nm) based on λ₁, as well as the center wavelength λ₁. Accordingly, the longest wavelength (λ₁+δ nm) constituting the optical signal pulse with the center wavelength λ₁ is relatively slow in its transmission speed compared with other wavelengths, in which, thus, dispersion occurs severely as the transmission distance becomes longer. Meanwhile, the shortest wavelength (λ₁−δ nm) is relatively faster in its transmission speed compared with other wavelengths, in which the least amount of dispersion may occur even in the case that a transmission distance is long. Thus, in order to compensate for the dispersion of the longest wavelength (λ₁+δ nm) constituting the optical signal pulse with the center wavelength λ₁, a reflection path within the chirp fiber grating needs to be shortened, while in order to compensate for the dispersion of the shortest wavelength (λ₁−δ nm) constituting the optical signal pulse, the reflection path in the chirp fiber grating needs to be relatively long to compensate for the dispersion of the optical signal pulse over the long distance transmission.

In the present exemplary embodiment, the TDCMs 310 may perform a precise dispersion compensation operation on all of a plurality of wavelength signals transmitted via the optical fiber based on one of the plurality of wavelength signals.

The second demultiplexers 320 may be connected to each of the plurality of first dispersion compensators 310 and split the signals output from the first dispersion compensators 310 into signals of different channels according to their wavelengths and output the same. In the present exemplary embodiment, the second demultiplexers 320 may split the signals, which have been split into the high band signal and the low band signal by the first demultiplexer 360, by wavelength. In the present exemplary embodiment, a 16:1 demultiplexer may be used as the second demultiplexer 320.

The second dispersion compensators 330 are connected to the respective channels which have been split by the second demultiplexers 320 and compensate for wavelength dispersion of each of the output optical signals of mutually different wavelengths. In the present exemplary embodiment, the second dispersion compensators 330 maybe fixed dispersion compensator modules (FDCMs).

The FDCMs 330 may compensate fixed dispersion. The fixed dispersion may be a chromatic dispersion set per unit length of a waveguide having a fixed refractivity. The fixed dispersion may be relatively fixed over the environmental conditions of the optical fiber. For example, 17 ps/nn·km with respect to a standard single mode fiber may represent a substantially 17 picosecond (ps) chromatic dispersion in a 10-kilometer system transmitting data with a bandwidth of 0.1 nanometer (nm). The FDCM may be economical compared with the TDCM.

In the present exemplary embodiment, the FDCMs 330 may compensate signals which have been dispersion-compensated based on one wavelength signal by the TDCMs 310. In the present exemplary embodiment, the FDCMs 330 may correspond to the number of split channels. In this case, the FDCM 330 may be omitted for a channel with respect to the optical signal whose wavelength is used as the reference in the TDCMs 310.

In this manner, in the present exemplary embodiment, the transmitted optical signals are first split by band by using the first demultiplexer 360, the precise dispersion compensation operation is performed on the signals of the respective bands by using the TDCMs 310, the precisely compensation-compensated signals of the respective bands are secondly split by channels by using the demultiplexers 320, and the split signals are allowed to pass through the FDCMs 330, thus performing precise dispersion compensation operation. In addition, because the required number of relatively high-priced TDCMs may be reduced, a more economical optical transmission system can be implemented.

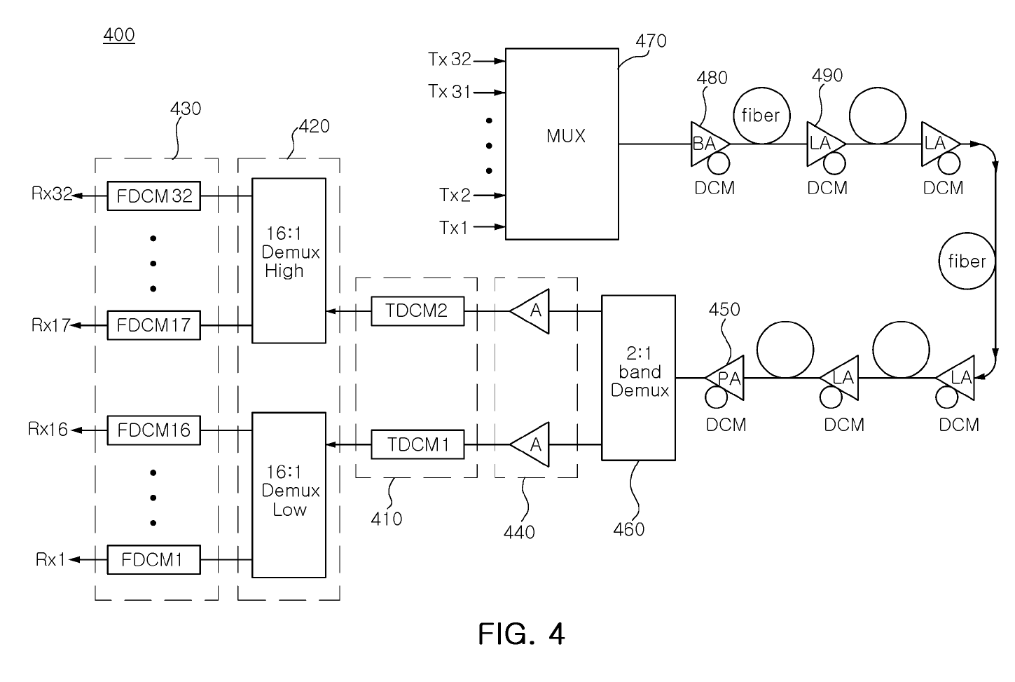

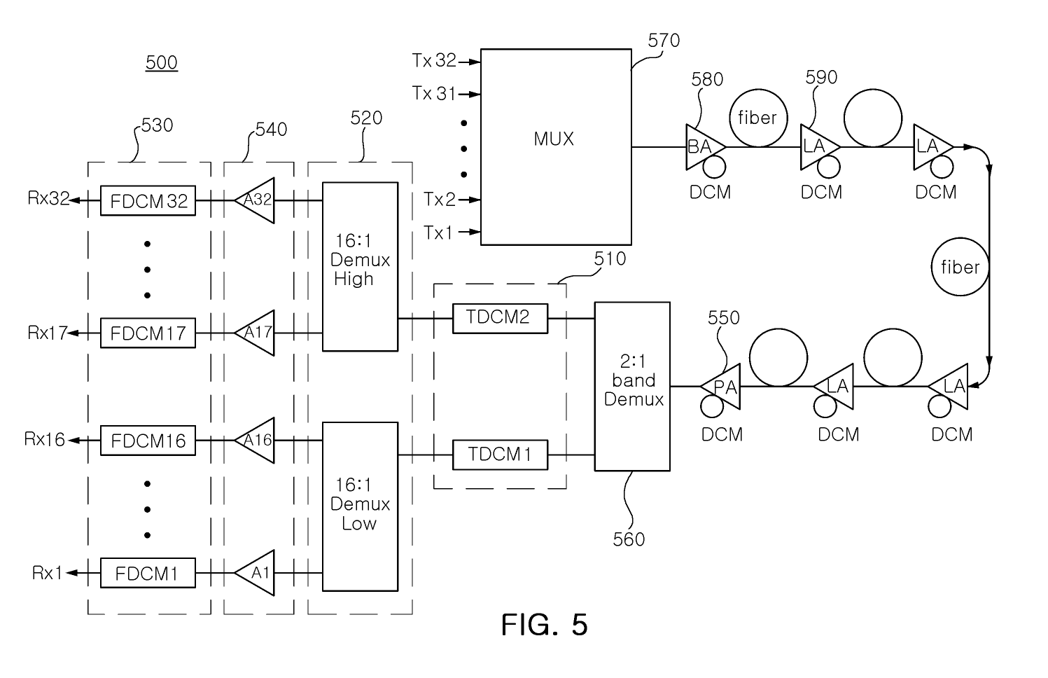

FIGS. 4 and 5 are schematic block diagrams of an optical transmission system according to another exemplary embodiment of the present invention.

As shown in FIGS. 4 and 5, an optical transmission system 400 further includes pre-amplifiers and/or optical amplifiers added to the optical transmission system according to the exemplary embodiment of FIG. 3.

With reference to FIG. 4, the optical transmission system 400 according to the present exemplary embodiment may include a first demultiplexer 460, first dispersion compensators 410, second demultiplexers 420, second dispersion compensators 430, and optical amplifiers 440.

In the present exemplary embodiment, the first demultiplexer 460, the first dispersion compensators 410, the second demultiplexers 420, and the second dispersion compensators 430 are the same as those described above with reference to FIG. 3, so its detailed description will be omitted.

The optical amplifiers 440 may amplify the signals of respective bands which have been split by the first demultiplexer 460 and transfer the amplified signals to the first dispersion compensators 410. If the power of the optical signal of each channel which has been split by the first demultiplexer 460 is low, the optical amplifiers 440 may amplify the signals.

The optical transmission system 400 according to the present exemplary embodiment may further include a pre-amplifier (PA) 450 connected to a front end of the first demultiplexer 460.

The PA 450 may amplify a signal transmitted through the optical fiber, compensate dispersion of the signal by using a dispersion compensation module (DCM), amplify the dispersion-compensated signal, and transmit the amplified signal to the first demultiplexer 460.

With reference to FIG. 5, the optical transmission system 500 according to the present exemplary embodiment may include a first demultiplexer 560, first dispersion compensators 510, second demultiplexers 520, second dispersion compensators 530, and optical amplifiers 540.

In the present exemplary embodiment, the first demultiplexer 560, the first dispersion compensators 510, the second demultiplexers 520, and the second dispersion compensators 530 are the same as those described above with reference to FIG. 3, so its detailed description will be omitted.

The optical amplifiers 540 may amplify the signals of respective wavelengths which have been split by the second demultiplexers 520 and transfer the amplified signals to the second dispersion compensators 530. If the power of the optical signal of each channel which has been split by the second demultiplexers 520 is low, the optical amplifiers 540 may amplify the signals.

The optical transmission system 500, according to the present exemplary embodiment, may further include a pre-amplifier (PA) 550 connected to a front end of the first demultiplexer 560.

The PA 550 may amplify a signal transmitted through the optical fiber, compensate for dispersion of the signal by using a dispersion compensation module (DCM), amplify the dispersion-compensated signal, and transmit the amplified signal to the first demultiplexer 560.

As set forth above, according to exemplary embodiments of the invention, the optical transmission system uses different dispersion compensators according to bands of signals received by the reception end thereof, so dispersion compensation can be precisely performed.

While the present invention has been shown and described in connection with the exemplary embodiments, it will be apparent to those skilled in the art that modifications and variations can be made without departing from the spirit and scope of the invention as defined by the appended claims.

What is claimed is:

1. An optical transmission system in which a plurality of optical signals, each having a different wavelength, are transmitted via a single optical fiber, the system comprising:
a first dispersion compensator configured to compensate for wavelength dispersion based on a single wavelength of a plurality of signals transmitted via the optical fiber;
a demultiplexer connected to the first dispersion compensator, splitting signals output from the first dispersion compensator into different channels according to their wavelengths, and outputting the same; and
a plurality of second dispersion compensators connected to each channel split by the demultiplexer, and compensating for each wavelength dispersion of the mutually different wavelength optical signals.

2. The system of claim 1, wherein the first dispersion compensator is a tunable dispersion compensator module (TDCM).

3. The system of claim 1, wherein the second dispersion compensator is a fixed dispersion compensator module (FDCM).

4. The system of claim 1, further comprising:
a plurality of optical amplifiers respectively connected to the second dispersion compensators and amplifying each of the channel signals which have been split by the demultiplexer.

5. The system of claim 1, further comprising:
a pre-amplifier configured to amplify a signal input to the first dispersion compensator.

6. The system of claim 5, further comprising:
a plurality of optical amplifiers respectively connected to each of the second dispersion compensators and amplifying each of the channel signals which have been split by the demultiplexer.

7. An optical transmission system in which a plurality of optical signals each having a different wavelength are transmitted via a single optical fiber, the system comprising:
a first demultiplexer configured to split a plurality of optical signals transmitted via the optical fiber into signals of pre-set bands and output the same;
a first dispersion compensator connected to each of band channels which have been split by the first demultiplexer and compensating for wavelength dispersion based on one wavelength among a plurality of signals included in output signals of each band;
a plurality of second demultiplexers connected to each of the plurality of first dispersion compensators, splitting signals output from the first dispersion compensators into signals of different channels according to their wavelengths, and outputting the same; and
a plurality of second dispersion compensators connected to each of the channels which have been split by the plurality of second demultiplexers and compensating for wavelength dispersion of each of the mutually different wavelength optical signals as outputted.

8. The system of claim 7, wherein the first dispersion compensators are tunable dispersion compensator modules (TDCMs).

9. The system of claim 7, wherein the second dispersion compensators are fixed dispersion compensator modules (FDCMs).

10. The system of claim 7, further comprising:
a plurality of optical amplifiers connected to a front stage of each of the first dispersion compensators and amplifying each signal of each band output from the first demultiplexer.

11. The system of claim 7, further comprising:
a pre-amplifier configured to amplify a signal input to the first demultiplexer.

12. The system of claim 7, further comprising:
a plurality of optical amplifiers connected to each of the second dispersion compensators and amplifying each of channel signals which have been split by the second demultiplexers.
